(19) United States
(12) Patent Application Publication
(10) Pub. No.: US 2007/0179082 A1
(43) Pub. Date: Aug. 2, 2007

(54) Dryer-added fabric care articles

(75) Inventors: George Kavin Morgan III, Hamilton, OH (US); Zai Liu, West Chester, OH (US); Melissa Jane Wene, Lebanon, OH (US); Darren Franklin King, West Chester, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/363,720

(22) Filed: Feb. 28, 2006

Related U.S. Application Data
(60) Provisional application No. 60/763,482, filed on Jan. 30, 2006.

(51) Int. Cl. C11D 3/00

(52) U.S. Cl. 510/515

(57) ABSTRACT

Dryer-added fabric conditioning articles that comprise friable microcapsules, wherein the microcapsules comprise a blooming perfume composition, provide consumers an impactful freshness experience while wearing clothing that is treated by the article. The microcapsules that are deposited on treated clothing rupture upon the mechanical stresses imposed upon the microcapsules through daily activities of wearing clothing such as putting on socks or putting on a coat. Furthermore, perfume microcapsules also allows the consumer to have a delightful scent experience on fabrics which have been stored even for long durations of time due to their ability to protect perfume from volatilization to the surrounding air space.

### CROSS REFERENCES TO RELATED APPLICATIONS

This application claims priority to U.S. Provisional Application Ser. No. 60/763,482, filed Jan. 30, 2006, the disclosure of which is incorporated by reference herein.

### FIELD OF INVENTION

The present invention relates to dryer-added articles that comprise perfume microcapsules.

### BACKGROUND OF THE INVENTION

Consumers are continually expressing the desire to have scent on their fabrics that last longer & throughout the entire day. Current fabric softeners, especially dryer sheets, fall short in fulfilling this consumer need. With the growing & evolving scent trends in today's market place, especially in candles & the aircare category, consumers want volatile scents such as fruity, citrus, green, lighter florals, and the like on their fabric. The issue is that the perfume ingredients which are needed to produce these character types do not readily deposit onto clothing because they are usually lost during the drying process given, inter alia, high temperatures.

Dryer sheets are a convenient vehicle for delivering freshness (via perfume) onto consumers' clothing. Long-lasting freshness (scent that lasts for several days) is particularly appealing to the dryer sheets consumer, and as a result of this, numerous ways to encapsulate perfume so as to increase its ability to last on clothing have been described. These encapsulation routes include formation of a β-Cylodextrin (starch)/water/perfume complex, perfume inclusion in porous inorganic carrier particles, and perfume adsorption onto silica particles. However, inherent limitations are readily apparent for each of these technologies. For example, β-cyclodextrin perfume technologies allow for the protection of volatile type materials through the dryer such as perfume ingredients but are still not easily detected by the user on their fabrics. In order for the user to appreciate these character types, water physically needs to be applied to the fabric to hydrolyze the bond between the starch & the perfume raw material (e.g., drying off with a towel or sweating). Furthermore, beta-cylodextrin/water/perfume complex, has a low, about 12% on average, perfume-loading level and is only effective (for in-use freshness) in the presence of water.

There is a continuing need to provide a dryer-added article that delivers top-note, volatile perfumes to fabric.

### SUMMARY OF THE INVENTION

The present invention attempts to addresses this and other needs by providing, in a first aspect of the invention, a dryer-added fabric conditioning article comprising a friable perfume microcapsule and a blooming perfume composition, wherein the perfume microcapsule encapsulates a blooming perfume composition, wherein the blooming perfume composition comprises perfume ingredients, and wherein at least about 25%, by weight of said perfume composition, of perfume ingredients have a boiling point equal or lower than about 250° C.

Methods and kits for using the articles of the present invention are also provided.

### DETAILED DESCRIPTION OF THE INVENTION

The present invention relates, in part, on the surprising discovery that certain perfume microcapsules, when deposited on fabric, exhibit a bloom of perfume upon rupturing. These perfume microcapsules rupture through the mechanical stresses applied on clothing while being worn. The perfume microcapsules of the present invention not only enable top-note scent characters to deposit easily onto fabrics after the drying process, but also allows the consumer to experience these scent types throughout the day while wearing their article of clothing. Microcapsules rupture and release perfume by a mechanical means (e.g., friction)—not a chemical means (e.g., water hydrolysis). Minimal fracture pressure is needed to break the structure such as normal everyday physical movements such as taking off a jacket; pulling a shirt over your head; or taking off/putting on socks. Furthermore, perfume microcapsules also allow the consumer to have a delightful scent experience on fabrics which have been in storage even for long durations of time due to their ability to protect perfume from volatilization to the surrounding air space. With the articles of the present invention, we are able to delight users with the scents they desire on their fabrics throughout the day and even after storage of their fabrics.

Perfume Microcapsules:

Encapsulation of perfume or other materials in small capsules (i.e., microcapsules), typically having a diameter less than 300 microns, is generally well known. Typically, these microcapsules comprise a spherical hollow shell of water insoluble material, typically polymer material, within which the active material, such as perfume, is contained. Microcapsules are described in the following references: US 2003/215417 A1; US 2003/216488 A1; US 2003/158344 A1; US 2003/165692 A1; US 2004/071742 A1; US 2004/071746 A1; US 2004/072719 A1; US 2004/072720 A1; EP 1,393,706 A1; US 2003/203829 A1; US 2003/195133 A1; US 2004/087477 A1; US 2004/0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. RE 32,713; U.S. Pat. No. 4,234,627. Microcapsules may be prepared using a range of conventional methods known to those skilled in the art for making shell capsules, such as Interfacial polymerization, and polycondensation. See e.g., U.S. Pat. No. 3,516,941, U.S. Pat. No. 4,520,142, U.S. Pat. No. 4,528,226, U.S. Pat. No. 4,681,806, U.S. Pat. No. 4,145,184; GB 2,073,132; WO 99/17871; and MICROENCAPSULATION: Methods and Industrial Applications Edited by Benita and Simon (Marcel Dekker, Inc. 1996). It is recognized; however, that many variations with regard to materials and process steps are possible. Non-limiting examples of materials suitable for making shell of the microcapsule include urea-formaldehyde, melamine-formaldehyde, phenol-formaldehyde, gelatin, polyurethane, polyamides.

In one embodiment of the invention, the shell of the microcapsules comprises an aminoplast resin. A method for forming such shell capsules includes polycondensation. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents (e.g., toluene diisocyanate, divinyl benzene, butanediol diacrylate etc.) may also be used and secondary wall polymers may also be used as appropriate, e.g. anhydrides and their derivatives, particularly polymers and co-polymers of maleic anhydride as disclosed in WO 02/074430. In another embodiment, the shell of the microcapsules comprise urea-formaldehyde; melamine-formaldehyde; or combinations thereof.

The microcapsules of the present invention should be friable in nature. Friability refers to the propensity of the microcapsules to rupture or break open when subjected to direct external pressures or shear forces. For purposes of the present invention, the microcapsules utilized are “friable” if, while attached to fabrics treated therewith, they can be ruptured by the forces encountered when the capsule-containing fabrics are manipulated by being worn or handled (thereby releasing the contents of the capsule).

In one embodiment, the shell capsules typically have a mean diameter in the range 1 micrometer to 100 micrometers, alternatively from 5 micrometers to 80 microns, alternatively from 10 micrometers to 75 micrometers, and alternatively between 15 micrometers to 50 micrometers. The particle size distribution can be narrow, broad or multimodal.

In another embodiment, microcapsules vary in size having a maximum diameter between about 5 microns and about 300 microns, alternatively between about 10 microns and about 200 microns. As the capsule particle size approaches 300 microns, e.g. 250 microns), a reduction in the number of capsules entrained in the fabric may be observed.

In another embodiment, the capsules utilized in the present invention generally have an average shell thickness ranging from about 0.1 micron to 50 microns, alternatively from about 1 micron to about 10 microns.

In another embodiment, the microcapsules comprise a loading/complexation level of from about 50% to about 90%, alternatively from about 60% to about 80%, alternatively from about 65%% to about 75%, by weight of the blooming composition. This loading/complexation property of the perfume microcapsules of the present invention is advantageous versus other technologies such as beta-cyclodextrin. The advantages may include, but are not limited to, one or more of the following: (i) the ability to use a reduced total perfume level, e.g., in neat perfume (direct add); in perfume microcapsules; or combinations thereof; (ii) avoiding cost in processing and lost material through processing; (iii) delivering a high level of perfume while not affecting process product disposition or process parameters; and (iv) delivering a high level of perfume to fabric while avoiding a high level of neat product odor, which can be a consumer negative.

Suppliers of microcapsules may include International Flavors & Fragrances (IFF), Reed Pacific, and Appleton. An example of a suitable microcapsule for purposes of the present invention includes Perfume Microcapsules (PMCs) from Appleton. Other examples may include WIZARD from Reed Pacific, and EVERLAST from IFF. For a preferred embodiment, the shell is formed by cross-linking aldehydes and amine functionalities. In one embodiment, the encapsulated blooming perfume composition may, in one embodiment, comprise from about 3 to about 300 different perfume ingredients, preferably with minimal modifiers which include viscosity or hydrophobicity modifiers. Typical viscosity modifiers include, but not limited to, silicone oil, gums, and waxes. Typical hydrophobic modifiers include, but not limited to, isopropyl myristate, mineral oil, dipropylenemethyl ether (DPM). Such modifiers may be used at less than 50%, alternatively less than 40%, alternatively less than 30%, alternatively less than 20%, alternatively less than 10%, alternatively less than 5%, alternatively less than 1%, alternatively about 0%, alternatively at least 0.1% but not greater than 50%, by weight of total perfume composition. Without wishing to be bound by theory, the overuse of modifiers reduces the efficiency of the scent experience imparted by the perfume microcapsules of the present invention.

Once microcapsules containing a perfume composition of the present invention have been attached to fabrics being treated, it is, of course, necessary to manipulate the treated fabrics in a manner sufficient to rupture the microcapsules and thereby release the perfume composition. Microcapsules of the type utilized herein have friability characteristics such that the ordinary fabric manipulation which occurs when the treated fabrics are worn or used is sufficient for the attached microcapsules to impart a noticeable odor to the fabric. A significant number of attached microcapsules can be broken by the normal forces encountered when treated garments are worn. For fabric articles which are not worn, the normal household handling operations such as folding, crumpling etc. can serve as fabric manipulation sufficient to rupture the attached microcapsules. The perfume composition of the present invention surprisingly maximizes the effect of the microcapsules bursting by providing a perfume composition that “blooms” upon the microcapsules rupturing.

The friable microcapsules of the present invention are distinguished from moisture-activated microcapsules, such as those capsules comprising of cyclodextrin that burst upon contact with moisture; a wax comprising microcapsule such as those described in U.S. Pat. No. 5,246,603; and starch-based microcapsule also described in U.S. Pat. No. 5,246,603.

Blooming Perfume

The present invention is based, in part, upon the surprising discovery that the blooming perfume compositions of the present invention maximizes the opportunity for the consumer a unique scent experience during the wearing, folding, and even after storage. When fabric deposited microcapsules are ruptured. In one embodiment, the perfume microcapsule encapsulates a blooming perfume composition, wherein the blooming perfume composition, in the absence of water, comprises from about 5% to about 95%, alternatively from about 20% to about 90%; alternatively from about 30% to about 85%, and alternatively from about 40% to about 80%, by the total weight of the perfume microcapsule and the encapsulated perfume composition, also in absence of water.

The term “blooming perfume composition” as used herein means a perfume composition that comprises at least about 25%, alternatively at least about 35%, alternatively at least about 45%, alternatively at least about 55%, alternatively at least about 65%, by weight of the perfume composition, of blooming perfume ingredients, wherein the blooming perfume ingredients are those having a boiling point (B.P.) equal to or lower than about 250° C., more preferably equal to or lower than about 250° C., wherein the B.P. is measured at the normal standard pressure.

The boiling points of many perfume ingredients are given in, e.g., “Perfume and Flavor Chemicals (Aroma Chemicals),” S. Arctander, published by the author, 1969. Other boiling point values can be obtained from different chemistry handbooks and databases, such as the Beilstein Handbook, Lange's Handbook of Chemistry, and the CRC Handbook of Chemistry and Physics. When a boiling point is given only at a different pressure, usually at a pressure lower than the standard pressure (760 mm Hg), the boiling point at standard pressure can be approximately estimated by using boiling point-pressure monographs, such as those given in “The Chemist's Companion,” A. J. Gordon and R. A. Ford, John Wiley & Sons Publishers, 1972, pp. 30-36. When applicable, the boiling point values can also be calculated by computer programs, based on molecular structural data, such as those described in “Computer-Assisted Prediction of Normal Boiling Points of Pyrans and Pyrroles,” D. T. Stanton et al, J. Chem. Inf. Comput. Sci., 32 (1992), pp. 306-316, “Computer-Assisted Prediction of Normal Boiling Points of Furans,” Tetrahydrofurans, and Thiophenes,” D. T. Stanton et al, J. Chem. Inf. Comput. Sci., 31 (1992), pp. 301-310, and references cited therein, and “Predicting Physical Properties from Molecular Structure,” R. Murugan et al, Chemtech, June 1994, pp. 17-23.

Non-limiting examples of blooming perfume ingredients that are useful in the articles of the present invention are given in U.S. Pat. Pub. No. 2005/0192207 A1, published Sep. 1, 2005, ¶29-31.

In one embodiment, the blooming perfume compositions of the present invention comprises at least about 3 different blooming perfume ingredients, preferably at least about 4 different blooming perfume ingredients, more preferably at least about 5 different blooming perfume ingredients, and even more preferably at least about 6 different blooming perfume ingredients.

In the perfume art, some materials having no odor or very faint odor are used as diluents or extenders. Non-limiting examples of these materials are dipropylene glycol, diethyl phthalate, triethyl citrate, isopropyl myristate, and benzyl benzoate. These materials are used for, e.g., diluting and stabilizing some other perfume ingredients. For purposes of this invention, these materials are not counted as a “blooming perfume ingredient.”

In one embodiment, the perfume ingredient that comprises the blooming perfume composition is chosen from at least of the following: blooming perfume ingredient is chosen from the group consisting of allo-ocimene, allyl caproate, allyl heptoate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, beta gamma hexenol, camphene, camphor, carvacrol, laevo-carveol, d-carvone, laevo-carvone, cinnamyl formate, citral (neral), citronellol, citronellyl acetate, citronellyl isobutyrate, citronellyl nitrile, citronellyl propionate, cuminic alcohol, cuminic aldehyde, Cyclal C, cyclohexyl ethyl acetate, decyl aldehyde, dihydro myrcenol, dimethyl benzyl carbinol, dimethyl benzyl carbinyl acetate, dimethyl octanol, diphenyl oxide, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, fenchyl alcohol, flor acetate (tricyclo decenyl acetate), frutene (tricyclo decenyl propionate), gamma methyl ionone, gamma-n-methyl ionone, gamma-nonalactone, geraniol, geranyl acetate, geranyl formate, geranyl isobutyrate, geranyl nitrile, hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, isoamyl alcohol, alpha-ionone, beta-ionone, gamma-ionone, alpha-irone, isobornyl acetate, isobutyl benzoate, isobutyl quinoline, isomenthol, isomenthone, isononyl acetate, isononyl alcohol, para-isopropyl phenylacetaldehyde, isopulegol, isopulegyl acetate, isoquinoline, cis-jasmone, lauric aldehyde (dodecanal), Ligustral, d-limonene, linalool, linalool oxide, linalyl acetate, linalyl formate, menthone, menthyl acetate, methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, alpha-iso “gamma” methyl ionone, methyl nonyl acetaldehyde, methyl octyl acetaldehyde, methyl phenyl carbinyl acetate, methyl salicylate, myrcene, neral, nerol, neryl acetate, nonyl acetate, nonyl aldehyde, octalactone, octyl alcohol (octanol-2), octyl aldehyde, orange terpenes (d-limonene), para-cresol, para-cresyl methyl ether, para-cymene, para-methyl acetophenone, phenoxy ethanol, phenyl acetaldehyde, phenyl ethyl acetate, phenyl ethyl alcohol, phenyl ethyl dimethyl carbinol, alpha-pinene, beta-pinene, prenyl acetate, propyl butyrate, pulegone, rose oxide, safrole, alpha-terpinene, gamma-terpinene, 4-terpinenol, alpha-terpineol, terpinolene, terpinyl acetate, tetrahydro linalool, tetrahydro myrcenol, tonalid, undecenal, veratrol, verdox, vertenex, viridine, and combinations thereof.

In one embodiment, substantive perfume ingredients, which can be used as part of blooming perfume compositions in articles of the present invention, are those having a B.P. higher than about 250° C. Non-limiting examples of such perfume ingredients include those described in U.S. Pat. Pub. No. 2005/0192207 A1, published Sep. 1, 2005, ¶36.

Another aspect of the invention provides for the article to comprise an optional perfume component comprising at least one of the following: (a) a moisture-activated perfume microcapsule comprising a perfume carrier and an encapsulated perfume composition; (b) a pro-perfume; (c) a low odor detection threshold perfume ingredients; (d) neat perfume; and (e) mixtures thereof. In one embodiment, the article is free or substantially free of any one or more of the aforementioned perfume components.

Minimization of Perfume Ingredients Comprising an Aldehyde Functionality

Another aspect of the invention provides for a blooming perfume composition that minimizes the amount of perfume ingredients that contain an aldehyde functionality. For purposes of the present invention the term “perfume ingredient comprising an aldehyde functionality” means any perfume ingredient that comprises at least one aldehyde moeity (—CHO) in its molecular structure. Without wishing to be bound by theory, it is believed that a perfume ingredient comprising an aldehyde functionality may be chemically bonded to and/or physically entrapped in the cell wall of a friable perfume micro-particle thereby rendering the perfume ingredient unavailable to evaporate into the headspace and thus ineffective as part of the blooming perfume composition.

In one embodiment, the blooming perfume composition comprises less than about 90%, alternatively about 70%, alternatively about 50%, alternatively about 30%, alternatively about 20%, alternatively about 10%, by weight of the blooming perfume composition, of a perfume ingredient comprising an aldehyde functionality. In another embodiment, the perfume composition comprises at least about 0.1%, alternatively 1%, by weight of the blooming perfume composition, of the perfume ingredient comprising an aldehyde functionality.

In one embodiment, the perfume ingredient comprising an aldehyde functionality is chosen from at least one of the following:

2-Methyl-2-Butenal; 2-Nonenal (Iris Aldehyde); 2-Tridecenal, 2-Undecenal; 3,5,5-Trimethyl Hexanal; 3; Methyl-2-Butenal; 3-Methylthio Propanal; 5-Methyl Furfural; 6-Nonenal; 9-Decenal; alpha-Methyl; Cinnamic Aldehyde; alpha-Pinyl iso-Butyraldehyde; Amyl Cinnamic Aldehyde; Anisic Aldehyde; Benzaldehyde; Bergamal; Bourgenal; Butyl Cinnamic Aldehyde; Campal (IFF); Cinnamic Aldehyde; cis-2-Hexenal; cis-3-Hexenal; cis-4-Decenal; Citronellal; Citronellyl OxyAcetaldehyde; Cumin Aldehyde; Cyclotropal; cymal; Decyl Aldehyde; Ethoxy Citronellal; Florhydral; Folial; Furfural; Geraldehyde; Geranial; Geranoxyl Acetaldehyde; Glutaraldehyde; Helional; Heptanal; Hexanal; hexyl cinnamic aldehyde; Hydratropic Aldehyde; Hydroxycitronellal; Inonanal (PPF); iso-Cyclamal; iso-Cyclo Citral; Lauric Aldehyde; Ligustral (“Cyclal C”); Lilial; Liminal; Lyral; Mefranal; Melonal; (2,6-DiMethyl-2-Heptenal); Methoxy Citronellal; Methyl Nonyl Acetaldehde; Methyl Octyl Acetaldehyde; Methyl Salicylaldehyde; m-Hydroxy Benzaldehyde; Myrtenal; Neral; Neraldehyde; Nonanal; Octanal; Perilla Aldehyde; Phenyl Acetaldehyde; Phenylpropanal; p-Hydroxy Benzaldehyde; Safranal; Salicylaldehyde; Sinensal; trans-2,4-Decadienal; trans-2-cis-6-Nonadienal; trans-2-Hexenal; trans-2-Pentenal; trans-4-Decenal; Trifernal; Undecenal, Undecyl Aldehyde; Veratraldehyde, Verdural; Vernaldehyde; Vetival; or combinations thereof.

Dryer Added Articles

The perfume microcapsules of the present invention are deposited on to fabric by using the articles of the present invention in an automatic laundry dryer. The term “dryer-added article” is used herein in the broadest sense to include any article that is suitable to delivering the perfume microcapsules, and the blooming perfume compositions encapsulated therein, of the present invention to fabric in an automatic laundry drying machine.

Examples of dryer-added articles include those described in U.S. Pat. Nos. 3,989,63; 4,000,340; 4,055,248; 4,073,996; 4,022,938; 4,764,289; 4,808,086; 4,103,047; 4,014,432; 3,736,66; 3,701,202; 3,634,947; 3,633,538; 3,435,537; 6,604,297; and 6,787,510. See also International Patent Publication Nos.: WO 00/27991; and WO 00/65141.

In one embodiment, the article comprises a substrate. An example of a substrate includes a sheet. The sheet may be chosen from a paper, woven, or non-woven sheet, such as those described in U.S. Pat. No. 3,686,025. A substrate comprising a sponge is yet another example. An example of a non-woven dryer sheet is one from BBA Fiber Web. A commercially available example of an article comprising a substrate and fabric conditioning composition includes a dryer sheet such as those sold under the trademark BOUNCE.

In a preferred embodiment, the dryer-added article further comprises a fabric conditioning composition. A “fabric conditioning composition” is herein defined as a composition that imparting one or more fabric care benefits such as softening, anti-static, color protection, etc., to fabrics. In one embodiment, the fabric care composition is disposed on the substrate (e.g., such as in a dryer sheet). In an alternative embodiment, the article of the present invention comprises a fabric condition composition without a substrate. Examples include dispensing the fabric conditioning composition, along with the perfume microcapsules of the present invention, through a dispenser affixed to the outside surface of the dryer or inside surface of the dryer barrel or inside door, or integral to the dryer itself.

Other examples of articles that may comprise the microcapsules of the present invention include those multiple use dryer-added described in U.S. Pat. Pub. Nos.: 2005/0192207; 2003/0192197; and 2003/0195130. In one embodiment, the article comprises a dryer-added, multiple use, article that is releasable attached to an inside surface of a dryer, preferably the dryer barrel, more preferably the fin of the dryer barrel. An example of a commercially available dryer bar is the X-STATIC in-dryer fabric softening bar from Ecolab, Inc.

In one embodiment, the article comprises a substrate and perfume microcapsule of the present invention, wherein the article is free or substantially free of a fabric conditioning composition. In yet another embodiment, the article comprises a fabric conditioning composition and a perfume microcapsule of the present invention, wherein the article is free or substantially free of a substrate.

The articles of the present invention also comprise a fabric conditioning composition for imparting one or more fabric care benefits such as softening, anti-static, color protection, etc., to fabrics. The fabric conditioning compositions comprise one or more fabric conditioning actives, perfumed particles and optionally other minor components.

Fabric Conditioning Composition

The articles of the present invention may comprise a fabric conditioning composition. In turn, a fabric conditioning composition may comprises one or more fabric conditioning actives. Examples of fabric conditioning actives may include a fabric softening active and/or an antistatic active. The fabric care composition may comprise from at least about 0.001% to about 99.99%, alternatively about 1% to about 90%, alternatively from about 10% to about 50%, alternatively from about 15% to about 40% of one or more fabric conditioning actives by weight of the fabric care composition. In turn, the dryer-added article may comprise from at least about 0.001% to about 99.99%, alternatively about 1% to about 90%, alternatively from about 10% to about 50%, alternatively from about 15% to about 40% of a fabric conditioning composition by weight of the article.

The fabric softening actives can be one or a mixture of a quaternary ammonium compound, a tertiary amine and or its salts, an ethoxylated fatty material, a fatty acid, any fatty acid derivative, or a mixture thereof. Examples of fabric softening actives that may be useful in the articles are the compositions described in U.S. Pat. Nos. 4,103,047; 4,237,155; 3,686,025; 3,849,435; 4,073,996; and U.S. Pat. Publ. No. 2003/0195130, ¶¶14-17.

In one embodiment, the fabric softening active is chosen from at least one of the following: a quaternary ammonium compound as one described in U.S. Pat. No. 6,787,510, col. 4, line 12 et seq.; or a tertiary amine, as described in id. at col. 7, line 31 et seq.; or a nonionic softening active, id. at col. 8, line 63 et seq.; or a fatty acid, id. at col. 10, line 63 et seq.; or combinations thereof.

Optional Components

The fabric conditioning composition may further comprise optional components used in textile treatment compositions including one or more of the following: soil release polymer, anti-oxidants, colorants, preservatives, optical brighteners, opacifiers, stabilizers such as guar gum and polyethylene glycol, anti-shrinkage agents, anti-wrinkle agents, soil release agents, fabric crisping agents, reductive agents, spotting agents, germicides, fungicides, anti-corrosion agents, antifoam agents, and the like. In one embodiment, the fabric conditioning composition is free or substantially free of any one or more of the above-identified optional components.

Kits and Methods

One aspect of the invention provides for a kit comprising an article of the present invention, optionally comprising instructions, wherein preferably the instructions instruct the user to administer the article inside an automatic laundry dryer.

Another aspect of the invention provides for a method of treating fabric comprising the step of administering an article of the present invention into an automatic laundry dryer.

Different Blooming Perfume Composition within Same Dryer-Added Article

One aspect of the invention provides for a dryer-added article comprising a perfume microcapsule of the present invention encapsulated more than one type of blooming perfume compositions. For example, one embodiment of the invention provides for an article that comprises both a first microcapsule encapsulating a first blooming perfume composition and a second microcapsule encapsulating a second blooming perfume composition, wherein the first blooming perfume composition is different from the second blooming perfume composition. Another embodiment provides yet a third microcapsule encapsulating a third blooming perfume composition, wherein the third blooming perfume composition is different from the first and second blooming perfume compositions. By providing different blooming perfume compositions within the same dryer-added article, the consumer can experience multiple scent types within the same article which allows for a more holistic product experience. By separating these blooming perfume compositions this holistic product experience may not have otherwise be achieved if some of the perfume ingredients in the respective blooming perfume compositions are not compatible with each other—at least in the encapsulation environment of the perfume microcapsule.

### EXAMPLES

### Example 1

### Lab Scale Incorporation of Perfume Microcapsules in a Dryer Sheet is Described

A fabric conditioning composition is melted at a temperature sufficient for the composition to attain a molten state. Next, a desired amount of perfume microcapsules (PMC) of the present invention (in addition to any other fabric care ingredient(s) including but not limited to neat perfume(s), other perfume technology(s), &/or fabric care technologies) is added to the molten fabric conditioning composition and wherein the composition is mixed until a homogenous mixture is obtained. Thereafter, the homogenous mixture is poured onto a heated surface with a temperature that will allow the homogenous mixture to stay in a molten state. The temperature on the heated surface may remain at the desired, elevated level, by heating the surface with, for example, steam. Next, the molten, homogenous mixtures is impregnated or disposed onto a substrate, such as a non-woven sheet (such as in a BOUNCE dryer sheet substrate), at the desired weight amount. Finally, the substrate is removed from the surface to allow fabric conditioning composition mixture to achieve a solid state.

Examples of dryer sheet formulations suitable for use on non-woven dryer sheets include Examples A-C:

| | Example A | Example B | Example C |
|---|---|---|---|
| Ingredients | Wt. % | Wt. % | Wt. % |
| C Salt^{(a)} | 29.5 | 28.6 | 28.9 |
| KRA^{(b)} | 58.5 | 57.2 | 57.8 |
| Clay^{(c)} | 5.8 | 5.7 | 5.8 |
| Neat Perfume A^{(d)} | 3.8 | 1.7 | 0.6 |
| Perfume Microcapsule^{(e)} | 2.4 | 6.8 | 6.9 |
| (Appleton) with encapsulated | | | |
| blooming perfume | | | |
| composition^{(f)} | | | |
| Total | 100 | 100 | 100 |

^{(a)}Dimethyl Stearyl Amine & triple pressed Stearic Acid. Company: Peter Kramer
^{(b)}Di(tallow oxyethyl)hydroxyethylmethylammoniummethylsulfate. Company: Stepan
^{(c)}Calcium Monomorilonite. Company: Southern Clay
^{(d)}Frangrance. Company: Internally developed (Procter & Gamble) or externally such as Firmenich
^{(e)}Perfume Microcapsule Composition. Company: Appleton
^{(f)}Blooming Perfume Composition. Company: Internally developed (Procter & Gamble) or externally such as Firmenich

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

All documents cited in the DETAILED DESCRIPTION OF THE INVENTION are, in the relevant part, incorporated herein by reference; the citation of any document is not to be construed as an admission that it is prior art with respect to the present invention.

Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dryer-added fabric conditioning article comprising:
a) a substrate in the form of a sheet; and
b) a fabric conditioning composition;
c) a friable perfume microcapsule;
d) a blooming perfume composition;
(i) wherein the perfume microcapsule encapsulates the blooming perfume composition;
(ii) wherein the blooming perfume composition comprises perfume ingredients;
(iii) wherein at least about 25%, by weight of the blooming perfume composition, of perfume ingredients having a boiling point equal or lower than about 250° C.

2. The article of claim 1, wherein the blooming perfume composition comprises at least three different perfume ingredients.

3. The article of claim 2, wherein the wherein the blooming perfume composition comprises at least six different perfume ingredients; and wherein the friable microcapsules comprises a shell, wherein the shell comprises an aminoplast copolymer shell.

4. The article of claim 3, wherein said blooming perfume composition comprises of at least about 35%, by weight of said perfume composition, of perfume ingredients having a boiling point equal or lower than about 250° C.

5. The article of claim 4, wherein said blooming perfume composition comprises at least about 45%, by weight of said perfume composition, of perfume ingredients having a boiling point equal or lower than about 250° C.; and wherein the aminoplast copolymer shell is chosen from melamine-formaldehyde or urea-formaldehyde.

6. The article of claim 5, wherein said blooming perfume ingredient is chosen from the group consisting of allo-ocimene, allyl caproate, allyl heptoate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, beta gamma hexenol, camphene, camphor, carvacrol, laevo-carveol, d-carvone, laevo-carvone, cinnamyl formate, citral (neral), citronellol, citronellyl acetate, citronellyl isobutyrate, citronellyl nitrile, citronellyl propionate, cuminic alcohol, cuminic aldehyde, Cyclal C, cyclohexyl ethyl acetate, decyl aldehyde, dihydro myrcenol, dimethyl benzyl carbinol, dimethyl benzyl carbinyl acetate, dimethyl octanol, diphenyl oxide, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, fenchyl alcohol, flor acetate (tricyclo decenyl acetate), frutene (tricyclo decenyl propionate), gamma methyl ionone, gamma-n-methyl ionone, gamma-nonalactone, geraniol, geranyl acetate, geranyl formate, geranyl isobutyrate, geranyl nitrile, hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, isoamyl alcohol, alpha-ionone, beta-ionone, gamma-ionone, alpha-irone, isobornyl acetate, isobutyl benzoate, isobutyl quinoline, isomenthol, isomenthone, isononyl acetate, isononyl alcohol, para-isopropyl phenylacetaldehyde, isopulegol, isopulegyl acetate, isoquinoline, cis-jasmone, lauric aldehyde (dodecanal), Ligustral, d-limonene, linalool, linalool oxide, linalyl acetate, linalyl formate, menthone, menthyl acetate, methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, alpha-iso “gamma” methyl ionone, methyl nonyl acetaldehyde, methyl octyl acetaldehyde, methyl phenyl carbinyl acetate, methyl salicylate, myrcene, neral, nerol, neryl acetate, nonyl acetate, nonyl aldehyde, octalactone, octyl alcohol (octanol-2), octyl aldehyde, orange terpenes (d-limonene), para-cresol, para-cresyl methyl ether, para-cymene, para-methyl acetophenone, phenoxy ethanol, phenyl acetaldehyde, phenyl ethyl acetate, phenyl ethyl alcohol, phenyl ethyl dimethyl carbinol, alpha-pinene, beta-pinene, prenyl acetate, propyl butyrate, pulegone, rose oxide, safrole, alpha-terpinene, gamma-terpinene, 4-terpinenol, alpha-terpineol, terpinolene, terpinyl acetate, tetrahydro linalool, tetrahydro myrcenol, tonalid, undecenal, veratrol, verdox, vertenex, viridine, and combinations thereof.

7. The article of claim 6, wherein the perfume composition comprises less than about 60%, by weight of the perfume composition, of a perfume ingredient comprising an aldehyde functionality.

8. The article of claim 7, wherein the perfume composition comprises less than about 40%, by weight of the perfume composition, of a perfume ingredient comprising an aldehyde functionality.

9. The article of claim 8, wherein the perfume composition comprises less than about 20%, by weight of the perfume composition, of a perfume ingredient comprising an aldehyde functionality.

10. The article of claim 9, wherein the perfume ingredient comprising an aldehyde functionality chosen from at least one of the following:
2-Methyl-2-Butenal; 2-Nonenal (Iris Aldehyde); 2-Tridecenal, 2-Undecenal; 3,5,5-Trimethyl Hexanal; 3; Methyl-2-Butenal; 3-Methylthio Propanal; 5-Methyl Furfural; 6-Nonenal; 9-Decenal; alpha-Methyl; Cinnamic Aldehyde; alpha-Pinyl iso-Butyraldehyde; Amyl Cinnamic Aldehyde; Anisic Aldehyde; Benzaldehyde; Bergamal; Bourgenal; Butyl Cinnamic Aldehyde; Campal (IFF); Cinnamic Aldehyde; cis-2-Hexenal; cis-3-Hexenal; cis-4-Decenal; Citronellal; Citronellyl OxyAcetaldehyde; Cumin Aldehyde; Cyclotropal; cymal; Decyl Aldehyde; Ethoxy Citronellal; Florhydral; Folial; Furfural; Geraldehyde; Geranial; Geranoxyl Acetaldehyde; Glutaraldehyde; Helional; Heptanal; Hexanal; hexyl cinnamic aldehyde; Hydratropic Aldehyde; Hydroxycitronellal; Inonanal (PPF); iso-Cyclamal; iso-Cyclo Citral; Lauric Aldehyde; Ligustral (“Cyclal C”); Lilial; Liminal; Lyral; Mefranal; Melonal; (2,6-DiMethyl-2-Heptenal); Methoxy Citronellal; Methyl Nonyl Acetaldehde; Methyl Octyl Acetaldehyde; Methyl Salicylaldehyde; m-Hydroxy Benzaldehyde; Myrtenal; Neral; Neraldehyde; Nonanal; Octanal; Perilla Aldehyde; Phenyl Acetaldehyde; Phenylpropanal; p-Hydroxy Benzaldehyde; Safranal; Salicylaldehyde; Sinensal; trans-2,4-Decadienal; trans-2-cis-6-Nonadienal; trans-2-Hexenal; trans-2-Pentenal; trans-4-Decenal; Trifernal; Undecenal, Undecyl Aldehyde; Veratraldehyde, Verdural; Vernaldehyde; Vetival; or combinations thereof.

11. A multiple-use, dryer-added, fabric conditioning composition comprising:
(a) a fabric conditioning composition;
(b) a friable perfume microcapsule;
(c) a blooming perfume composition;
(i) wherein the perfume microcapsule encapsulates the blooming perfume composition;
(ii) wherein the blooming perfume composition comprises perfume ingredients;
(iii) wherein at least about 25%, by weight of the blooming perfume composition, of perfume ingredients having a boiling point equal or lower than about 250° C.; and
wherein the article is operably connectable to an inside surface of a clothes dryer.

12. The article of claim 11, wherein the blooming perfume composition comprises at least three different perfume ingredients.

13. The article of claim 12, wherein the wherein the blooming perfume composition comprises at least six different perfume ingredients, wherein the microcapsule comprises a shell, wherein the shell comprises an aminoplast copolymer shell.

14. The article of claim 13, wherein said blooming perfume composition comprises of at least about 35%, by weight of said perfume composition, of perfume ingredients having a boiling point equal or lower than about 250° C.

15. The article of claim 14, wherein said blooming perfume composition comprises at least about 45%, by weight of said perfume composition, of perfume ingredients having a boiling point equal or lower than about 250° C.; and wherein the aminoplast copolymer shell is chosen from melamine-formaldehyde or urea-formaldehyde.

16. The article of claim 15, wherein said blooming perfume ingredient is chosen from the group consisting of allo-ocimene, allyl caproate, allyl heptoate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, beta gamma hexenol, camphene, camphor, carvacrol, laevo-carveol, d-carvone, laevo-carvone, cinnamyl formate, citral (neral), citronellol, citronellyl acetate, citronellyl isobutyrate, citronellyl nitrile, citronellyl propionate, cuminic alcohol, cuminic aldehyde, Cyclal C, cyclohexyl ethyl acetate, decyl aldehyde, dihydro myrcenol, dimethyl benzyl carbinol, dimethyl benzyl carbinyl acetate, dimethyl octanol, diphenyl oxide, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, fenchyl alcohol, flor acetate (tricyclo decenyl acetate), frutene (tricyclo decenyl propionate), gamma methyl ionone, gamma-n-methyl ionone, gamma-nonalactone, geraniol, geranyl acetate, geranyl formate, geranyl isobutyrate, geranyl nitrile, hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, isoamyl alcohol, alpha-ionone, beta-ionone, gamma-ionone, alpha-irone, isobornyl acetate, isobutyl benzoate, isobutyl quinoline, isomenthol, isomenthone, isononyl acetate, isononyl alcohol, para-isopropyl phenylacetaldehyde, isopulegol, isopulegyl acetate, isoquinoline, cis-jasmone, lauric aldehyde (dodecanal), Ligustral, d-limonene, linalool, linalool oxide, linalyl acetate, linalyl formate, menthone, menthyl acetate, methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, alpha-iso “gamma” methyl ionone, methyl nonyl acetaldehyde, methyl octyl acetaldehyde, methyl phenyl carbinyl acetate, methyl salicylate, myrcene, neral, nerol, neryl acetate, nonyl acetate, nonyl aldehyde, octalactone, octyl alcohol (octanol-2), octyl aldehyde, orange terpenes (d-limonene), para-cresol, para-cresyl methyl ether, para-cymene, para-methyl acetophenone, phenoxy ethanol, phenyl acetaldehyde, phenyl ethyl acetate, phenyl ethyl alcohol, phenyl ethyl dimethyl carbinol, alpha-pinene, beta-pinene, prenyl acetate, propyl butyrate, pulegone, rose oxide, safrole, alpha-terpinene, gamma-terpinene, 4-terpinenol, alpha-terpineol, terpinolene, terpinyl acetate, tetrahydro linalool, tetrahydro myrcenol, tonalid, undecenal, veratrol, verdox, vertenex, viridine, and combinations thereof.

17. The article of claim 16, wherein the perfume composition comprises less than about 60%, by weight of the perfume composition, of a perfume ingredient comprising an aldehyde functionality.

18. The article of claim 17, wherein the perfume composition comprises less than about 40%, by weight of the perfume composition, of a perfume ingredient comprising an aldehyde functionality.

19. The article of claim 18, wherein the perfume composition comprises less than about 20%, by weight of the perfume composition, of a perfume ingredient comprising an aldehyde functionality.

20. The article of claim 9, wherein the “formaldehyde comprising perfume ingredient is chosen from at least one of the following:
2-Methyl-2-Butenal; 2-Nonenal (Iris Aldehyde); 2-Tridecenal, 2-Undecenal; 3,5,5-Trimethyl Hexanal; 3; Methyl-2-Butenal; 3-Methylthio Propanal; 5-Methyl Furfural; 6-Nonenal; 9-Decenal; alpha-Methyl; Cinnamic Aldehyde; alpha-Pinyl iso-Butyraldehyde; Amyl Cinnamic Aldehyde; Anisic Aldehyde; Benzaldehyde; Bergamal; Bourgenal; Butyl Cinnamic Aldehyde; Campal (IFF); Cinnamic Aldehyde; cis-2-Hexenal; cis-3-Hexenal; cis-4-Decenal; Citronellal; Citronellyl OxyAcetaldehyde; Cumin Aldehyde; Cyclotropal; cymal; Decyl Aldehyde; Ethoxy Citronellal; Florhydral; Folial; Furfural; Geraldehyde; Geranial; Geranoxyl Acetaldehyde; Glutaraldehyde; Helional; Heptanal; Hexanal; hexyl cinnamic aldehyde; Hydratropic Aldehyde; Hydroxycitronellal; Inonanal (PPF); iso-Cyclamal; iso-Cyclo Citral; Lauric Aldehyde; Ligustral (“Cyclal C”); Lilial; Liminal; Lyral; Mefranal; Melonal; (2,6-DiMethyl-2-Heptenal); Methoxy Citronellal; Methyl Nonyl Acetaldehde; Methyl Octyl Acetaldehyde; Methyl Salicylaldehyde; m-Hydroxy Benzaldehyde; Myrtenal; Neral; Neraldehyde; Nonanal; Octanal; Perilla Aldehyde; Phenyl Acetaldehyde; Phenylpropanal; p-Hydroxy Benzaldehyde; Safranal; Salicylaldehyde; Sinensal; trans-2,4-Decadienal; trans-2-cis-6-Nonadienal; trans-2-Hexenal; trans-2-Pentenal; trans-4-Decenal; Trifernal; Undecenal, Undecyl Aldehyde; Veratraldehyde, Verdural; Vernaldehyde; Vetival; or combinations thereof.
